(19) United States
(12) Patent Application Publication
(10) Pub. No.: US 2026/0224434 A1
(43) Pub. Date: Aug. 6, 2026

(54) POWERED TELESCOPIC FASCIA GUN

(71) Applicant: Fuzhou Bvenr E-commerce Co., Ltd., Fuzhou (CN)

(72) Inventor: PINGHUA WU, Nanchang (CN)

(21) Appl. No.: 19/026,958

(22) Filed: Jan. 17, 2025

(51) Int. Cl. A61H 23/00; A61H 23/02

(52) U.S. Cl. CPC A61H 23/006; A61H 23/0254; A61H 2201/0153; A61H 2201/0192; A61H 2201/0207; A61H 2201/0214; A61H 2201/025; A61H 2201/14; A61H 2201/1669; A61H 2201/1685

(57) ABSTRACT

A powered telescopic fascia gun is provided, which includes a fascia gun body and a massage component. One end of the fascia gun body is provided with a channel for reciprocating motion of a movable part, the movable part is connected to a power component provided in the fascia gun body. The movable part is provided with a first connector, the first connector is electrically connected to a battery in the fascia gun body through a controller. The massage component is detachably connected to the movable part and has heating and/or cooling functions. The massage component further includes a second connector, which is electrically connected to the first connector; the fascia gun body includes a handle, and the battery is provided in the handle. An outer circumference of the handle is sleeved with a telescopic sleeve, which is slidably connected to the handle.

### TECHNICAL FIELD

The present disclosure relates to the field of massager technologies, and in particular, to a powered telescopic fascia gun.

### BACKGROUND

Fascia gun is a type of massage equipment, such as the structure of a handgun, which includes a horizontal housing and a vertical handle. A massage head is provided at a front end of the housing, and a reciprocating drive device is installed inside the housing. The massage head and reciprocating drive device are mechanically connected to vibrate back and forth, thereby pressing the massage head on the muscles to vibrate them and achieve the effect of relaxing tendons and promoting blood circulation.

According to different needs, the massage part of the current fascia gun has heating or cooling functions, which can massage the muscles during a massage process. However, the massage head with heating and cooling functions usually contains a battery for charging. If the power is exhausted, it cannot be used, so it is not convenient enough for users.

### SUMMARY

The purpose of the present disclosure is to provide a powered telescopic fascia gun to solve problems raised in the background technology.

To achieve the above objectives, the present disclosure provides the following technical solution.

A power supply expandable fascia gun, including a fascia gun body and a massage component, where one end of the fascia gun body is provided with a channel for reciprocating motion of a movable part, and the movable part is connected to a power component provided in the fascia gun body, where the movable part is provided with a first connector, the first connector is electrically connected to a battery inside the fascia gun body through a controller; the massage component is detachably connected to the movable part and has heating and/or cooling function; the movable part is further provided with a second connector, and the second connector is electrically connected to the first connector;

the fascia gun body further includes a handle, and the battery is provided in the handle; an outer circumference of the handle is sleeved with a telescopic sleeve, which is slidably connected to the handle.

In some embodiments of the present disclosure, the handle has a length of 10-15cm, and has a total length of 20-30cm after adding the telescopic sleeve.

In some embodiments of the present disclosure, a lower end of the handle is provided with a clamping piece; an upper end and a lower end of an inner side of the telescopic sleeve are respectively provided with clamp slots that cooperate with the clamping piece.

In some embodiments of the present disclosure, one side of the massage component is provided with a plurality of vent holes; gas exchange is carried out inside through the reciprocating motion, so that an outer circumference of the massage component is wrapped with hot air.

In some embodiments of the present disclosure, the fascia gun body further includes a control part, the power component is rotatably connected to the control part; a locking structure is provided on one side of the control part to fix a current state of the power component; the power component is capable of being rotated and aligned with the handle.

In some embodiments of the present disclosure, the control part includes a shell, and a space configured to install the locking structure is provided on one side of the shell; an inner edge of the space is provided with a first gear ring; the locking structure includes a movable component; a circumference direction of the movable component is provided with a sawtooth that engages with the first gear ring; a convex second gear ring is provided at an end face of the movable component, and an outer circumference of the second gear ring is engaged with an inner circumference of a third gear ring; the third gear ring is provided at a side of the power component; a spring is provided between the power component and the movable component.

In some embodiments of the present disclosure, the power component includes a housing, and a driving motor is provided on an inner side of the housing; an output shaft of the driving motor is extended to the other side and is connected to a cam; the cam is eccentrically connected to a push rod, another end of the push rod is rotatably connected to the movable part.

In some embodiments of the present disclosure, the driving motor includes an outer cover, where a stator component is provided in the outer cover, a bracket is fixedly provided in the stator component; the bracket is extended to an outside of the outer cover so as to form at least three fixing parts; a plurality of bearings are fixedly provided in the bracket; a rotor component penetrates the bracket and is connected to the bearings;

the fixing parts are sleeved with a rubber sleeve, and the rubber sleeve is fixedly provided on a partition; the partition is provided on an inner side of the housing.

The beneficial effects of the present disclosure are that the second connector in the massage component of the present disclosure can be coupled and connected with the first connector. During a use of the fascia gun body, electrical energy of the battery is transmitted to the massage component through the first connector and the second connector, causing it to generate heat or cool and act on muscles of human body, thereby achieving a better massage effect.

In addition, by significantly increasing the length of the handle, in addition to conventional usage, the fascia gun can still reach corresponding areas for massage after the back muscles are stretched, thereby meeting needs of users in different usage scenarios.

Other features and advantages of the present disclosure will be described in detail in the following description on specific embodiments.

### BRIEF DESCRIPTION OF DRAWINGS

FIG. 1 is a schematic diagram of folding and storage of the present disclosure.

FIG. 2 is a diagram of a usage state of the present disclosure.

FIG. 3 is an overall disassembly diagram of the present disclosure

FIG. 4: is a three-dimensional sectional view of the present disclosure.

FIG. 5 is a disassembled diagram of a movable part of the present disclosure.

FIG. 6 is an external structural diagram of a massage component of the present disclosure.

FIG. 7 is a schematic diagram of other exchanges of the massage component of the present disclosure.

FIG. 8 is a plan sectional view of the present disclosure.

FIG. 9 is a structural diagram of a power component of the present disclosure.

FIG. 10 is a structural diagram of a driving motor of the present disclosure.

FIG. 11 is a structural diagram of a locking component of the present disclosure.

Numeral reference: 1- fascia gun body; 11- handle; 12- telescopic sleeve; 13- battery; 14- control part; 141- shell; 142- space; 143- first gear ring; 15- locking structure; 151- movable component; 152- sawtooth; 153- second gear ring; 154- third gear ring; 155- spring; 161- clamp slot; 162- clamping piece; 2- massage component; 21- vent hole; 22- connection part; 23- socket; 24- recess; 25- emboss; 26- second connector; 3- movable part; 31- shell body; 321- connecting piece; 322- flange; 323- clamp hole; 33- transition piece; 34- fixing piece; 35- first connector; 361- convex block; 362 arc-shaped notch; 4- power component; 41- housing; 42- driving motor; 421- outer cover; 422- stator component; 423- bracket; 424- fixing part; 425- bearing; 426- rotor component; 427- rubber sleeve; 428- partition; 43- cam; 44- push rod.

### DESCRIPTION OF EMBODIMENTS

Below, the technical solutions in the embodiments of the present disclosure will be clearly and completely described in combination with the accompanying drawings.

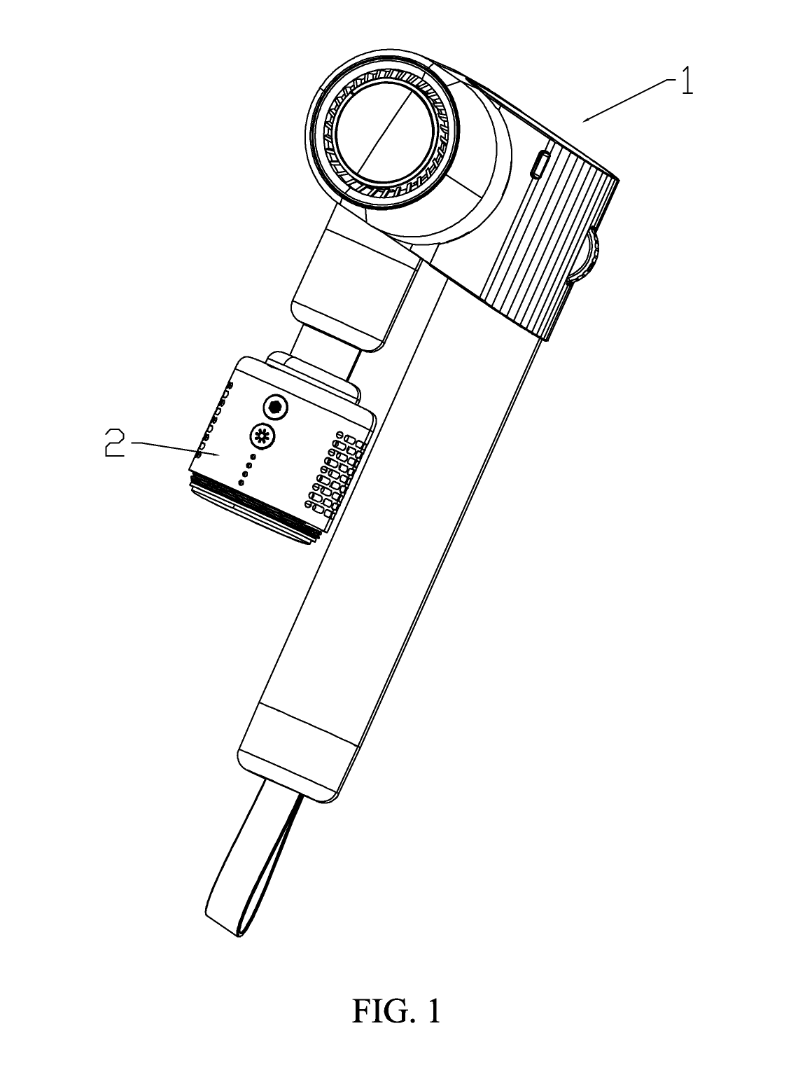

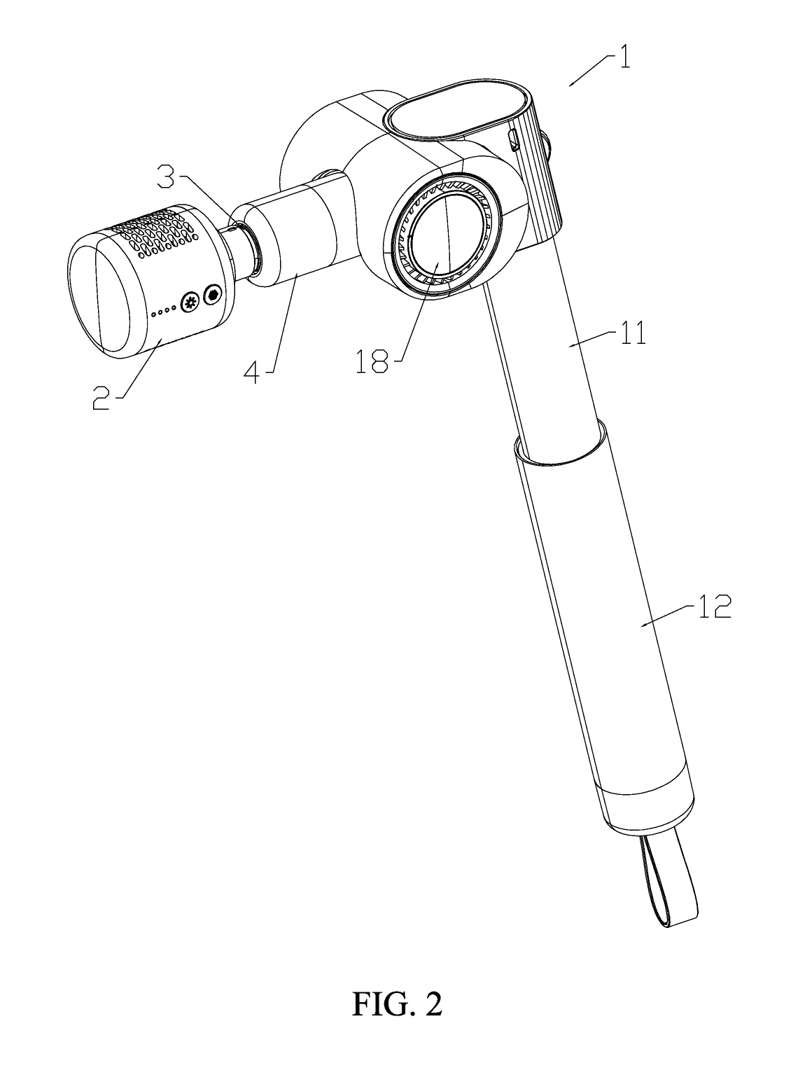

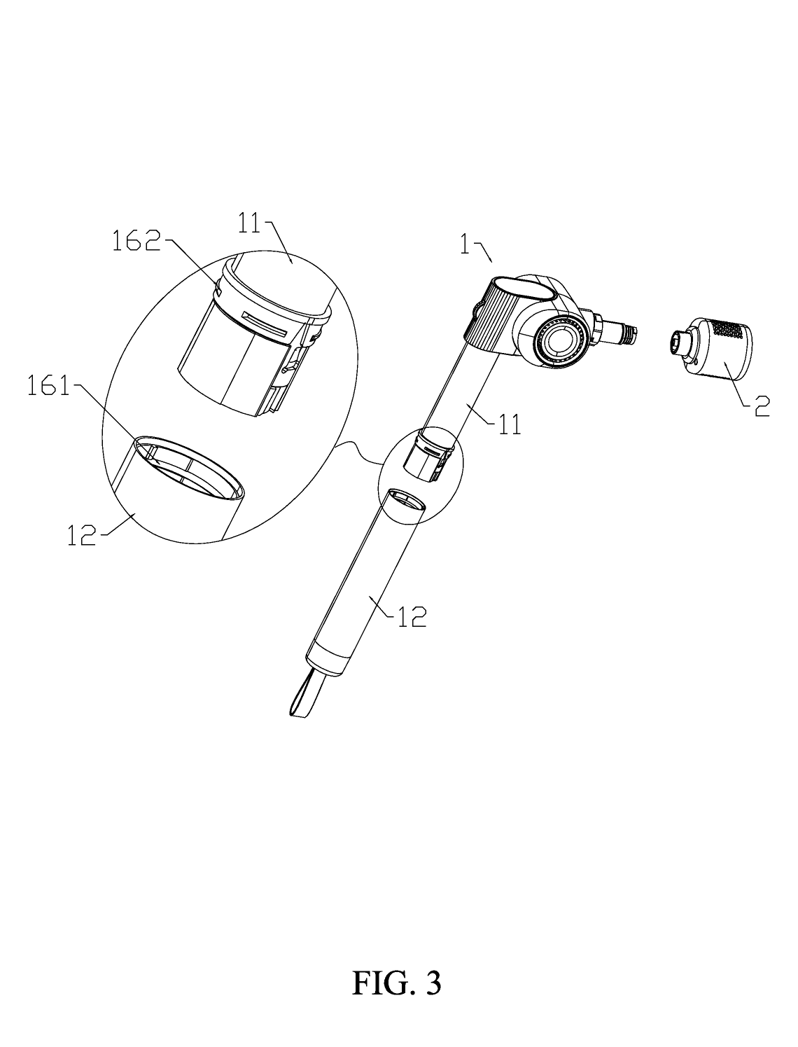

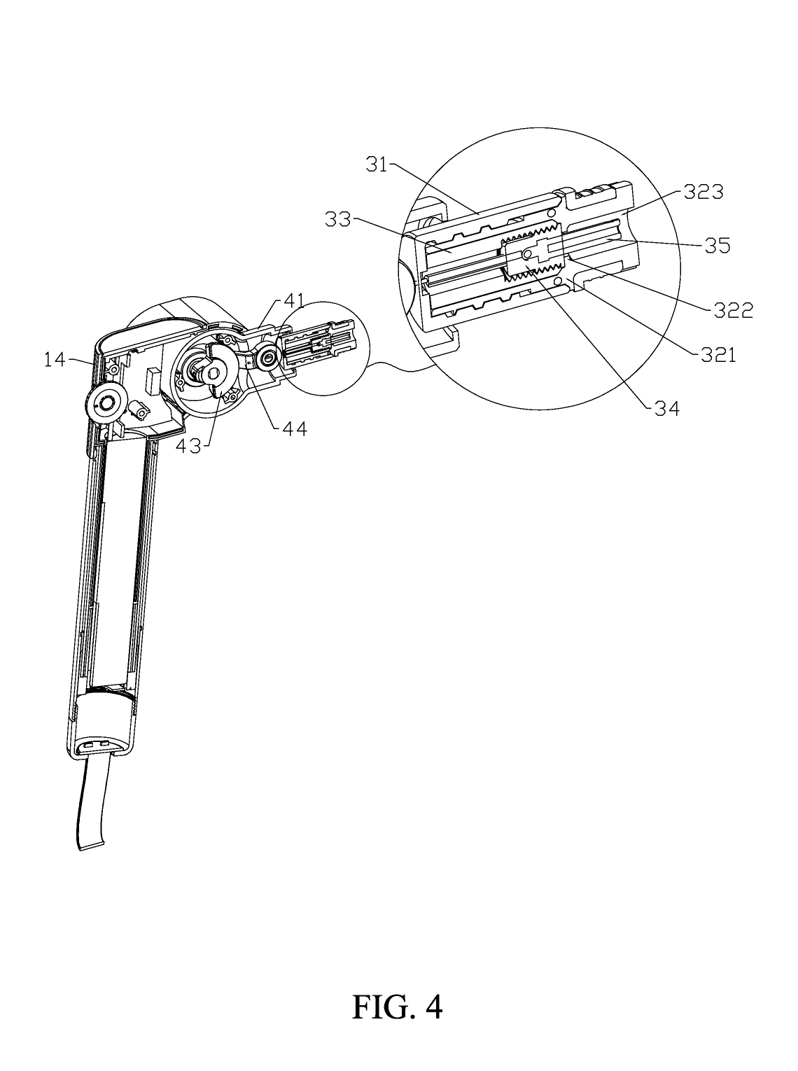

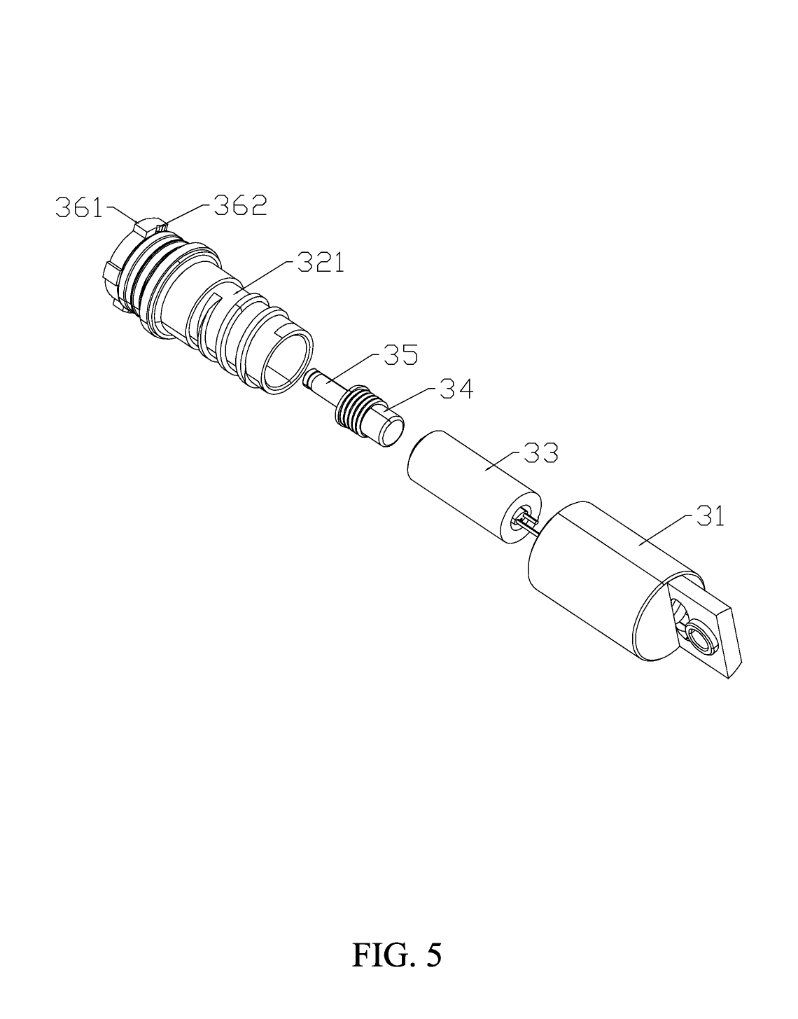

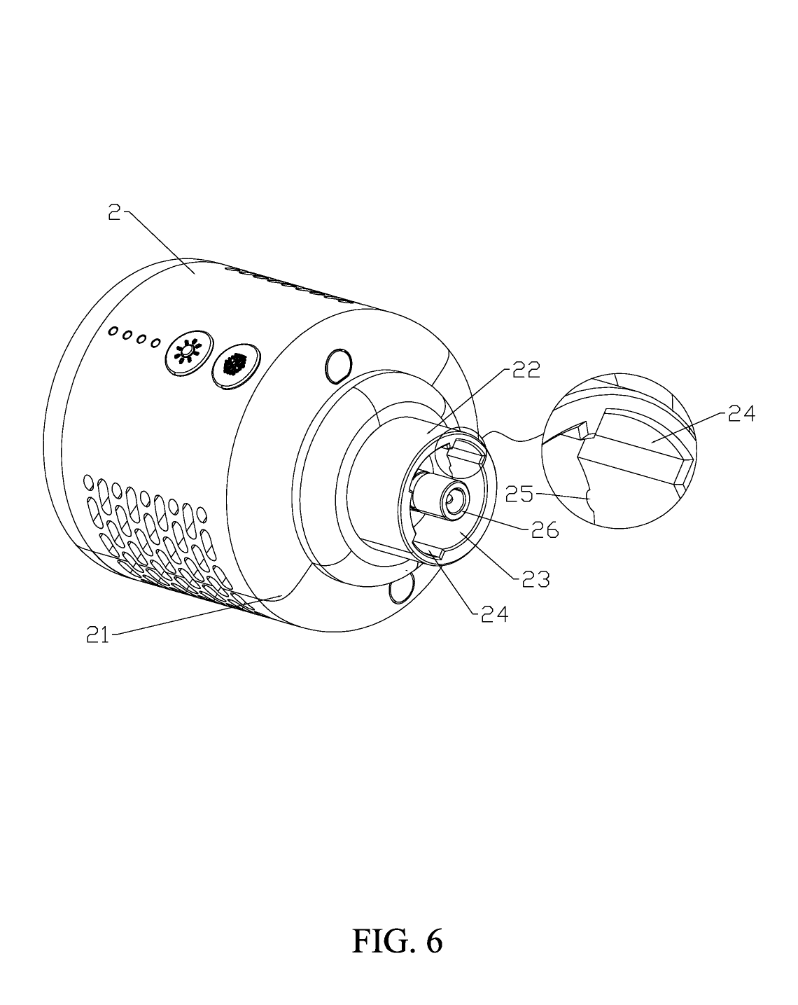

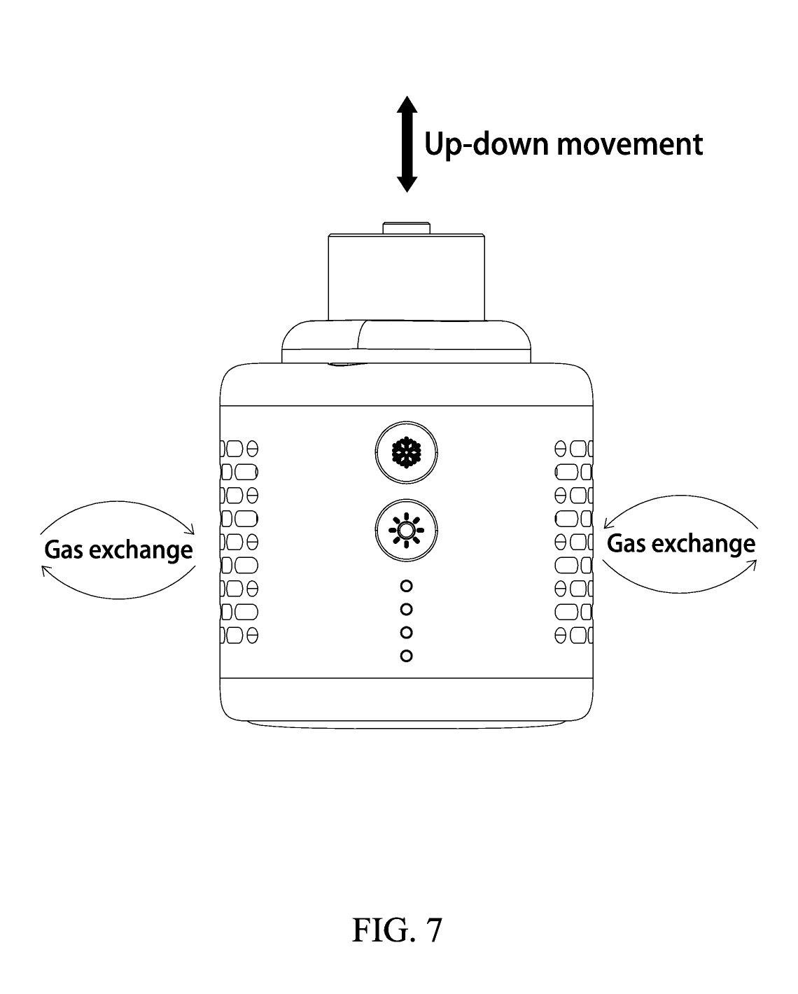

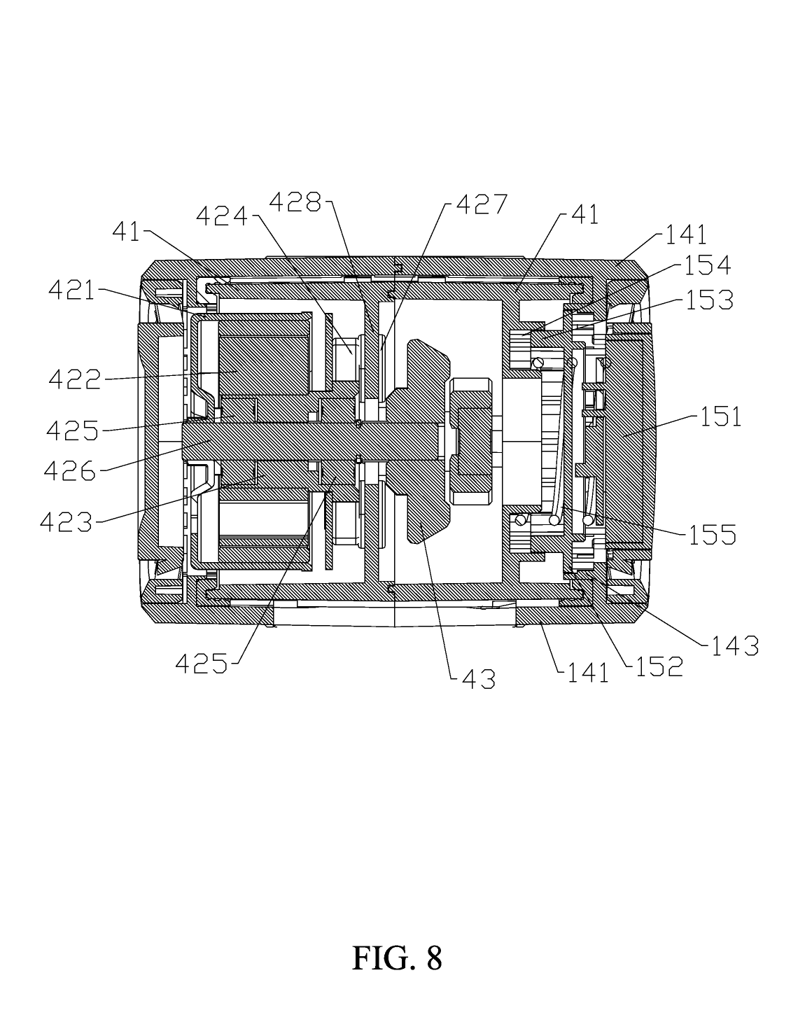

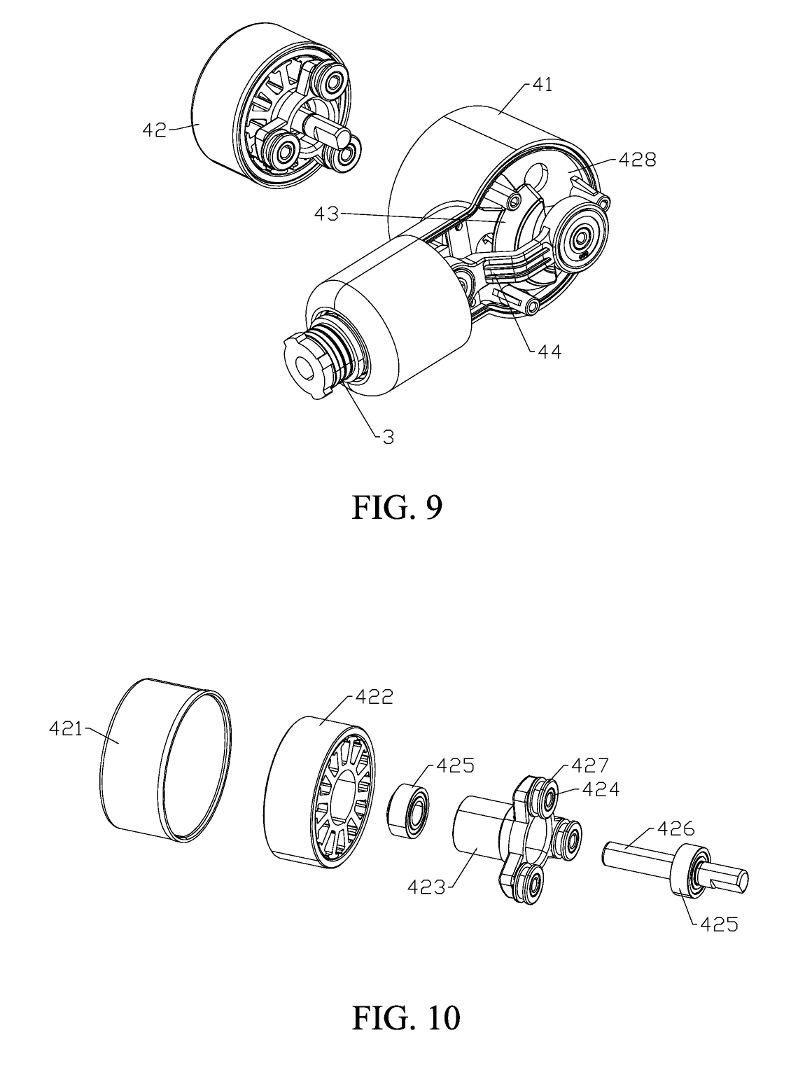

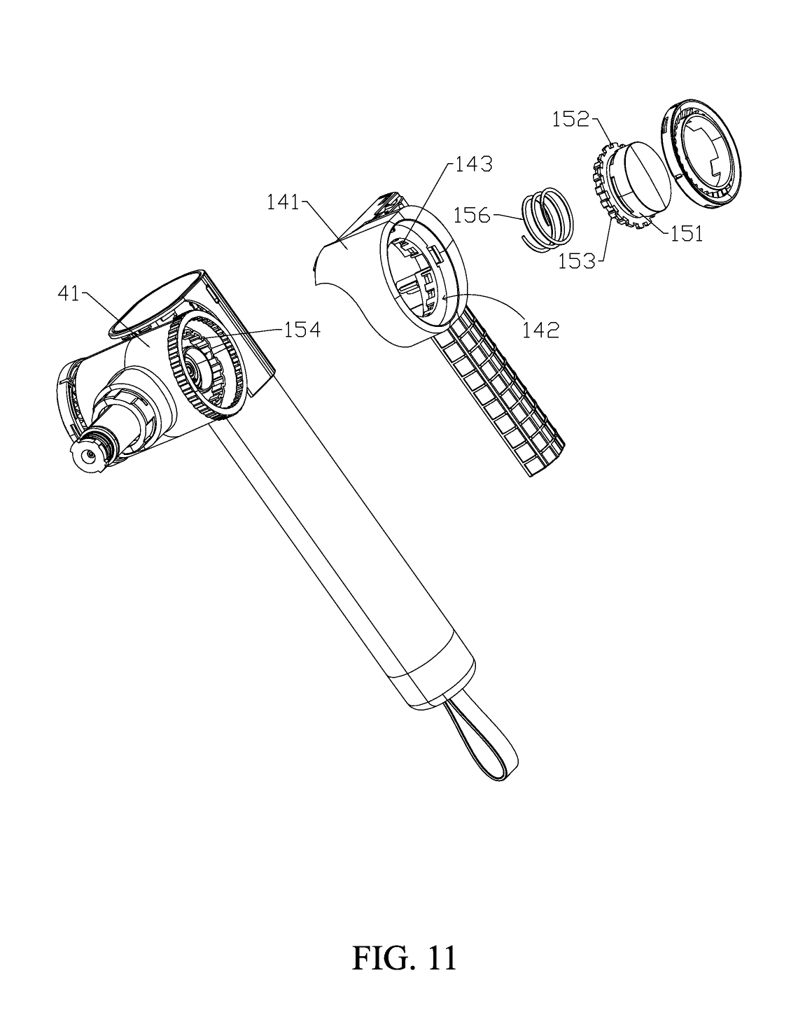

Please refer to FIGS. 1-11. The fascia gun described in the present disclosure aims to provide a user with a more convenient way of use, which includes a fascia gun body 1 and a massage component 2. One end of the fascia gun body 1 is provided with a channel; the movable part 3 is placed in the channel and connected to a power component 4 provided in the fascia gun body 1. It should be noted that the fascia gun body 1 should include necessary components that meet its normal functions, such as control components, adjustment components, power components, etc. Since this embodiment does not improve the above components, these components will not be described again.

The movable part 3 is arranged to be concentric with the channel, so the channel has a radial limiting effect on the movable part 3. The movable part 3 is connected to the channel in a sliding manner, and during operation, forward and backward swing of the power component 4 drives the movable part 3 to reciprocate in the channel. In addition, an adjusting component can be set in the fascia gun body 1, such as the adjustment way disclosed in CN117598897A, “a fascia gun with stepless amplitude adjustment”, to achieve the adjustment of a swing amplitude of the power component 4, so that a reciprocating frequency of the movable part 3 in the channel can be increased or decreased to meet needs of the user.

The movable part 3 is provided with a first connector 35, which is electrically connected to a battery 13 inside the fascia gun body 1 through a controller. The controller is provided with a power management module, which enables the first connector 35 to output stable voltage and current for external electrical use. The massage component 2 is detachably connected to the movable part 3, and the massage component 2 has heating and/or cooling functions. An internal structure of the massage component 2 can refer to the implementation modes of existing technology. The key point of this application is a second connector 26 in the massage component 2 can be coupled and connected to the first connector 35. During a use of the fascia gun body 1, electrical energy of the battery 13 is transmitted to the massage component 2 through the first connector 35 and the second connector 26, causing it to generate heat or cooling and it acts on muscles of human body, thereby providing a better massage effect.

The present disclosure provides an embodiment of the movable part 3, and the movable part 3 includes a shell body 31 and a connecting piece 321, the shell body 31 and the connecting piece 321 are connected by threads. The other part of the connecting piece 321 is located outside the shell body 31 for connecting with the massage component 2. The connecting piece 321 has a cavity inside, and a flange 322 is located in the cavity of the connecting piece 321, thereby dividing a space 142 into two parts. One end is a clamp hole 323, and the other end is an installation part. The installation part is embedded with a transition piece 33, the transition piece 33 is threaded with a fixing piece 34. An end of the fixing piece 34 is protruded from the transition piece 33; the flange 322 and a part of the transition piece 33 that is protruded from the fixing piece 34 are clamped and fixed. The fixing piece 33 is provided with the first connector 35, and the first connector 35 is inserted into the clamp hole 323.

The transition piece 33 is located inside the connecting piece 321 and will not loosen, and the end of the fixing piece 34 is protruded from the transition piece 33. Therefore, the fixing piece 34 is locked by threads and prevented from retracting from the transition piece 33 by clamping. This ensures that the first connector 35 will not loosen or deviate during the high-frequency reciprocating motion of the movable part 3 and ensuring stable transmission of electrical energy.

By using a power supply way of a built-in battery 13 in the fascia gun body 1 to provide energy to the massage component 2, it can eliminate user anxiety, reduce usage burden, and ensure that the massage component 2 can also achieve cooling or heating effects during normal use of the fascia gun body 1.

In an implementation mode, the massage component 2 is detachably connected to the movable part 3, and the user can replace different massage components 2 according to needs. Of course, whether the massage component 2 is enabled or not can be provided with necessary switch components for starting and turning off, thereby providing the user with more choices for use.

The fascia gun body 1 in the present disclosure includes a handle 11, the battery 13 is provided in the handle 11, and a telescopic sleeve 12 is sleeved on an outer circumference of the handle 11. The telescopic sleeve 12 is slidably connected to the handle 11. Generally, the telescopic sleeve 12 wraps around the handle 11, so the user holds the telescopic sleeve 12 in general use scenarios. When there are some special massage needs that cannot be touched while holding the fascia gun, the telescopic sleeve can be slid out of the handle 11 to increase a length of a grip part and achieve the purpose of use.

To explain a connection way between the movable part 3 and the massage component 2, there are a plurality of horizontally extending convex blocks 361 provided at an end of the connecting piece 321, an arc-shaped notch 362 is provided on the convex blocks 361. There is a connection part 22 located at an end of the massage component 2, a socket 23 for the connecting piece 321 to extend into is provided in the connecting part 22. There are a plurality of L-shaped recesses 24 on a side of the socket 23 that are compatible with the convex blocks 361. There is emboss 25 located in the recesses 24 that is compatible with the arc-shaped notch 362, the emboss 25 is configured to clamp and fix with the arc-shaped notch 362. When unlocking is needed, plastic deformation can be used to displace the arc-shaped notch 362 from the emboss 25.

In this embodiment of the present disclosure, the handle 11 has a length of 10cm-15cm, a total length is 20cm-30cm after adding the telescopic sleeve. Firstly, the handle 11 adopts an ultra-long design, which can accommodate a larger battery 13, thereby greatly increasing a running time of the fascia gun body 1. In the prior art, the fascia gun has a relatively small body size and a very limited range of extension and contraction, which also limits its usage scenarios. It should be noted that for fitness enthusiasts, fascia guns are generally used after fitness, when muscles expand and tense, and normal movements are sufficient. However, fascia guns are not limited to use after fitness. Ordinary people also use them when they are tired, especially after slight stretching, rendering the body more comfortable to use.

In this embodiment, expansion and contraction range of the grip part is significantly increased, and a lengthened grip part also brings a new way of use. The specific steps are as follows:

step 1: pulling out the telescopic sleeve 12 from the handle 11 to render the grip part to be longer;

step 2: holding the telescopic sleeve 12, then lifting and bending arms, this action can be done with one or both hands, raising arms to stretch the muscles in back and waist, while also stretching body; placing the fascia gun body 1 on the back, and the massage component 2 can reach a waist position;

step 3: activating the fascia gun body 1 to massage the position of the waist and back.

In this embodiment, a lower end of the handle 11 is provided with a clamping piece 162, an upper end and a lower end of an inner side of the telescopic sleeve 12 are respectively provided with clamp slots 161 that cooperate with the clamping piece 162. Whether in the contracted or extended state, a position of the telescopic sleeve 12 can be fixed to avoid sliding during use.

The massage component 2 in the existing technology also has a heating function, but a main heating part, except for the end, cannot dissipate most of the heat from the inside to the outside. It is not only difficult to dissipate heat, but also causes the massage component 2 to continuously heat up, affecting its service life. In the embodiment of the present disclosure, one side of the massage component 2 is provided with a plurality of vent holes 21. During use, the massage component 2 not only generates heat at its end to act on the muscles of the human body, but also expands the air inside the massage component 2, causing expanded hot air to be discharged from the vent holes 21 to the outside. During the reciprocating motion of the massage component 2, colder air from the outside is also sucked in through the vent holes 21, and then heated and discharged from the vent holes 21. Due to a relatively small amplitude of the reciprocating motion of the massage component 2, an outer circumference of the massage component 2 is wrapped with hot air through a gas exchange process, which also acts on muscle of an outer circumference of the massage area, thereby increasing the range of muscles involved, leading to increased blood circulation in this area, it has the effect of relieving fatigue and pain.

In this embodiment of the present disclosure, the fascia gun body 1 further includes a control part 14; the power component 4 is rotatably connected to the control part 14. A locking structure 15 is provided on one side of the control part 14 to fix a current state of the power component 4. The power component 4 can be rotated and aligned with the handle 11. Through this structure, folding and storage can be achieved when not in use, thereby reducing the occupation of the space 142.

To further explain the locking structure 15, the control part 14 includes a shell 141, and a space 142 configured to install the locking structure 15 is provided on one side of the shell 141. An inner edge of the space 142 is provided with a first gear ring 143. The locking structure 15 includes a movable component 151. It should be noted that the movable component 151 can be a whole or composed of a plurality of parts. A circumferential direction of the movable component 151 is provided with a sawtooth 152 that can engage with the first gear ring 143, and an end face of the movable component 151 is provided with a convex second gear ring 153. An outer circumference of the second gear ring 153 is engaged with an inner circumference of a third gear ring 154. The third gear ring 154 is provided on a side of the power component 4, and a spring 155 is provided between the power component 4 and the movable component 151. It should be noted that a structure for limiting the movable component 151 is provided in the shell 141 to prevent it from popping out under an action of the spring 155 and to avoid a left-and-right deviation. These structures are commonly used technical means or can be clearly seen by referring to the drawings in the present application, and will not be repeated here.

In the above structure, the shell 141 is fixed and cannot move. When the sawtooth 152 of the movable component 151 engages with the first gear ring 143, the movable component 151 cannot move. At the same time, the outwardly convex second gear ring 153 of the movable component 151 remains in engaging with the third gear ring 154 on the power component 4. At this time, a position of the power component 4 can be fixed.

When the power component 4 needs to be rotated, the movable component 151 is pressed to disengage the sawtooth 152 on the outer circumference of the movable component 151 from the first gear ring 143 on the shell 141, and the position restriction is released. At this time, the pressed state of the movable component 151 is maintained and the power component 4 is rotated. When an expected position is reached, the movable component 151 is released and is reset under the action of the spring 155. The sawtooth 152 of the movable component 151 engaging with the first gear ring 143 achieves fixation. In this embodiment, the sawtooth 152 and gear rings are used as limiting structures, which can achieve multi angle position adjustment in addition to storage, thereby meeting needs of users.

An embodiment of the present disclosure relates to the power component 4, the power component 4 includes a housing 41. A driving motor 42 is provided on one side of the housing 41, an output shaft of the driving motor 42 is extended to the other side and is connected to a cam 43. The cam 43 is eccentrically rotated and is connected to a push rod 44. The other end of the push rod 44 is rotatably connected to the movable part 3. In order to make the rotation smoother, a bearing 425 or other structure can be provided at a rotational connection position.

This embodiment focuses on an explanation of the driving motor 42, a partition 428 is provided inside the housing 41. The driving motor is provided on the partition 428, the driving motor 42 includes an outer cover 421. The outer cover 421 is provided with a stator component 422, and a bracket 423 is fixed in the stator component 422. The bracket 423 is extended to an outer side of the outer cover 421 to form at least three fixing parts 424. A plurality of bearings 425 are fixed in the bracket 423, and a rotor component 426 penetrate the bracket 423 and is connected to the bearings 425.

The motor used in the fascia gun in the existing technology is usually a fully sealed component. During installation, the bracket 423 can only be connected to the outer cover 421 of the motor. During operation, the cam 43 will generate significant vibration, which will be amplified by the outer cover 421 and act on the shell 141 through a rotating shaft. Therefore, the fascia gun vibration will be very large. The existing technology usually uses various gaskets to absorb the vibration at the position in contact with the motor, which will cause the structure very compact and may cause interference, rendering it difficult to effectively reduce the vibration. In this embodiment, the vibration at the shaft will be directly transmitted to the bracket 423 to avoid amplification of the vibration. The vibration will also be diverted by the bracket 423 to three fixed points to disperse the vibration. In addition, the fixing parts 424 are sleeved with a rubber sleeve 427, the rubber sleeve 427 can absorb some of the vibration and reduce the transmission of vibration to the partition 428. Furthermore, the three fixed points can not only effectively fix the driving motor 42, but also form a mutually constrained state to avoid deviation in the same direction.

For those skilled in the art, it is obvious that the present disclosure is not limited to the details of the exemplary embodiments described above, and can be implemented in other specific forms without departing from the spirit or essential features of the present disclosure. Therefore, from any point of view, the embodiments should be regarded as exemplary and non-limiting, and the scope of the present disclosure is limited by the appended claims rather than the above description. Therefore, it is intended to encompass all variations falling within the meaning and scope of the equivalent elements of the claims within the scope of the present disclosure. Any reference numerals in the claims should not be regarded as limiting the claims involved.

Furthermore, it should be understood that although this specification is described according to the embodiments, not each embodiment only contains an independent technical solution. This description in the specification is only for clarity, and those skilled in the art should consider the specification as a whole. The technical solutions in each embodiment can also be appropriately combined to form other embodiments that those skilled in the art can understand.

What is claimed is:

1. A powered telescopic fascia gun, comprising a fascia gun body and a massage component, wherein one end of the fascia gun body is provided with a channel for reciprocating motion of a movable part, and the movable part is connected to a power component provided in the fascia gun body,
wherein the movable part is provided with a first connector, the first connector is electrically connected to a battery inside the fascia gun body through a controller; the massage component is detachably connected to the movable part and has heating and/or cooling function; the movable part is further provided with a second connector, and the second connector is electrically connected to the first connector;
the fascia gun body further comprises a handle, and the battery is provided in the handle; an outer circumference of the handle is sleeved with a telescopic sleeve, which is slidably connected to the handle.

2. The powered telescopic fascia gun according to claim 1, wherein the handle has a length of 10-15cm, and has a total length of 20-30cm after adding the telescopic sleeve.

3. The powered telescopic fascia gun according to claim 1, wherein a lower end of the handle is provided with a clamping piece;
an upper end and a lower end of an inner side of the telescopic sleeve are respectively provided with clamp slots that cooperate with the clamping piece.

4. The powered telescopic fascia gun according to claim 1, wherein one side of the massage component is provided with a plurality of vent holes;
gas exchange is carried out inside through the reciprocating motion, so that an outer circumference of the massage component is wrapped with hot air.

5. The powered telescopic fascia gun according to claim 1, wherein the fascia gun body further comprises a control part, the power component is rotatably connected to the control part;
a locking structure is provided on one side of the control part to fix a current state of the power component;
the power component is capable of being rotated and aligned with the handle.

6. The powered telescopic fascia gun according to claim 5, wherein the control part comprises a shell, and a space configured to install the locking structure is provided on one side of the shell;
an inner edge of the space is provided with a first gear ring;
the locking structure comprises a movable component;
a circumference direction of the movable component is provided with a sawtooth that engages with the first gear ring;
a convex second gear ring is provided at an end face of the movable component, and an outer circumference of the second gear ring is engaged with an inner circumference of a third gear ring;
the third gear ring is provided at a side of the power component;
a spring is provided between the power component and the movable component.

7. The powered telescopic fascia gun according to claim 1, wherein the power component comprises a housing, and a driving motor is provided on an inner side of the housing;
an output shaft of the driving motor is extended to the other side and is connected to a cam;
the cam is eccentrically connected to a push rod,
another end of the push rod is rotatably connected to the movable part.

8. The powered telescopic fascia gun according to claim 7, wherein the driving motor comprises an outer cover, wherein a stator component is provided in the outer cover, a bracket is fixedly provided in the stator component;
the bracket is extended to an outside of the outer cover so as to form at least three fixing parts;
a plurality of bearings are fixedly provided in the bracket;
a rotor component penetrates the bracket and is connected to the bearings;
the fixing parts are sleeved with a rubber sleeve, and the rubber sleeve is fixedly provided on a partition;
the partition is provided on an inner side of the housing.
